(19) United States
(12) Patent Application Publication
(10) Pub. No.: US 2021/0011281 A1
(43) Pub. Date: Jan. 14, 2021

(54) LIGHT SCANNING APPARATUS, OBJECT DETECTING APPARATUS, LIGHT SCANNING METHOD, OBJECT DETECTING METHOD AND STORAGE MEDIUM

(71) Applicant: Dolphin Co., Ltd., Koshigaya (JP)

(72) Inventor: Zhihui DUAN, Kawaguchi (JP)

(21) Appl. No.: 16/725,134

(22) Filed: Dec. 23, 2019

(30) Foreign Application Priority Data
Jul. 10, 2019 (JP) 2019-128474

(51) Int. Cl. G02B 26/10; G01S 7/481; G02B 27/00

(52) U.S. Cl. CPC G02B 26/105; G01S 17/88; G02B 27/0031; G01S 7/4817

(57) ABSTRACT

The light scanning apparatus forms a plurality of primary scanning lines at different positions in a secondary scanning direction by a light beam, adjusts scanning range of the primary scanning lines so that first primary scanning lines scan a larger range in a primary scanning direction than the remaining primary scanning lines, by making the beam forming the first primary scanning lines pass through an optical member with refractive power. The optical member preferably includes a first optical element to refract a beam passing through a first primary scanning range more strongly to a direction of a first end of the primary scanning lines at closer positions to the first end, and a second optical element to refract a beam passing through a second primary scanning range more strongly to a direction of a second end of the primary scanning lines at closer positions to the second end.

### TECHNICAL FIELD

The invention relates to a light scanning apparatus and an light scanning method for beam scanning, an optical detecting apparatus for projecting a light beam to the outside and detecting light incident from the outside on the same optical axis as the projected light, an object detecting apparatus and an object detecting method for detecting an object located along an optical path of the scan beam, and a non-transitory machine-readable storage medium storing program instructions for controlling scanning by the light beam.

### BACKGROUND

The existing object detecting apparatus has been well-known in which it projects a pulse of laser beam outward and detects returned laser beam reflected by an object, thereby detects the distance and the object which is located on the optical path of the laser beam. Such object detecting apparatus is called LiDAR (Light Detection and Ranging).

In recent years, LiDAR has come to be applied in the field of autonomous driving of vehicles. In order to compensate for the shortcomings of a camera sensor which is susceptible to an external lighting environment and a milliwave radar which is of low resolution, and further to realize high-precision detection of a small obstacle in a driving environment, LiDAR is used in association with, for example, the camera sensor or the milliwave radar.

In such LiDAR, it is an important function to scan laser beam in the field of view and detect the returned light from an object. Such a technology has been recited, for example, in non-patent literature 1 (NPL1), patent literature 1 (PTL1), and patent literature 2 (PTL2). In addition, the applicant also filed a patent application regarding to patent literature 3 (PTL3).

### CITATION LIST

### Patent Literature

{PTL1} U.S. Pat. No. 9,869,754

{PTL2} US Patent Publication No. 2018/0113200

{PTL3} Japanese Patent No. 6521551

### Non Patent Literature

{NPL1} Cristiano Niclass, et al., “A 100-m Range 10-Frame/s 340×96-Pixel Time-of-Flight Depth Sensor in 0.18-μm CMOS”, IEEE JOURNAL OF SOLID-STATE CIRCUITS, Institute of Electrical and Electronics Engineers, FEBRUARY 2013, VOL. 48, NO. 2, p. 559-572.

### SUMMARY

NPL1 indicated a polygon mirror with three facets of different inclination angles is rotated to deflect a laser beam, then the laser beam is projected within a field of view of 4.5° in a vertical direction, and the returned light from the object is reflected on the same surface as that of projection on the polygon mirror and guided to a light detecting element for detection.

PTL1 indicated laser beam emitted from a light source is divided into two beams, the two beams are respectively incident to two scanning assemblies, the laser is deflected by the two scanning assemblies, and scanning is performed by the two beams in different ranges (see FIG. 17 and so on of PTL1). PTL1 further indicated light reception units corresponding to the respective scanning assemblies are provided to detect returned light of the laser beams projected from the corresponding scanning assemblies.

PTL2 indicated three scanning assemblies are provided, each laser beam emitted from three light sources is incident to corresponding scanning assemblies and deflected by the corresponding scanning assemblies respectively, and scanning is performed by the three laser beams in different ranges (see FIG. 2B and so on of PTL2). PTL2 further indicated light reception units corresponding to the respective scanning assemblies are provided to detect returned light of the laser beams projected from the corresponding scanning assemblies.

PTL3 indicated scanning with periodically changing light projection direction of a laser beam is implemented by a small and high-durability structure with an actuator using a torsion spring.

Meanwhile, in a LiDAR, extended field of view is always preferable. To meet this requirement, the polygon mirror indicated in NPL1 could be one of technical means. For example, a scanning range up to 180° can be achieved by a four-facet polygon mirror, and a scanning range up to 120° can be achieved even by a six-facet polygon mirror. However, in the case of polygon mirrors, it is difficult to achieve a compact device and low power consumption. Therefore, the polygon mirrors are not suitable for those devices to be mounted on a wearable device or a small mobility object such as a drone device.

On the other hand, although the actuator indicated in PTL3 might be downsized, torsion spring would be twisted to a larger angle in order to increase the scanning range. In such circumstance with large angle, stable scanning is difficult due to the shear stress limitation in the torsion spring.

From this point of view, if pluralities of scanning assemblies are used to scan different scanning ranges as indicated in PTL1 and PTL2, the scanning range of an apparatus can be extended. However, a plurality of scanning assemblies and light reception units are required, which results in a large size of the apparatus and increased manufacturing cost.

In other scanning applications except for LiDAR, the same problem arises as well if one wants to scan an arbitrary beam.

With consideration of the circumstances above, the present invention is proposed. The purpose is to realize a small and low cost construction so as to perform wide range scan with a light beam periodically changing light projection direction thereof.

For the purpose above, a light scanning apparatus of the present invention including: a scanning assembly configured to form a plurality of primary scanning lines at different positions in a secondary scanning direction by a light beam; and an adjusting member configured to adjust a scanning range of the plurality of primary scanning lines formed by the scanning assembly, so that first primary scanning lines among the plurality of primary scanning lines scan a larger range in a primary scanning direction than remaining primary scanning lines among the plurality of primary scanning lines. The adjusting member preferably adjusts the scanning range by making the light beam forming the first primary scanning lines pass through an optical member with refractive power so that the first primary scanning lines scan a larger range in a primary scanning direction than the remaining primary scanning lines.

In such a light scanning apparatus, the optical member preferably includes: a first optical element configured to refract a first light beam that passes through a first primary scanning range among the light beam forming the first primary scanning lines, so that the first light beam is more strongly refracted to a direction of a first end of the primary scanning lines at closer positions to the first end; and a second optical element configured to refract a second light beam that passes through a second primary scanning range among the light beam forming the first primary scanning lines, so that the second light beam is more strongly refracted to a direction of a second end of the primary scanning lines at closer positions to the second end, the second primary scanning range being closer to the second end than the first primary scanning range and not overlapping the first primary scanning range.

Preferably, surfaces of the first optical element and the second optical element through which the light beam passes are planar.

Preferably, the first optical element and the second optical element are adjacent in the primary scanning direction, and the optical scanning apparatus includes a first boundary controller configured to turn off the light beam while the light beam passes through a predetermined range around a boundary between the first optical element and the second optical element.

Preferably, each of the first primary scanning lines is formed with a gap between a first portion thereof formed by the light beam passing through the first optical element and a second portion thereof formed by the light beam passing through the second optical element, and the remaining primary scanning lines scan at least a range that covers the gaps in the primary scanning direction.

Preferably, in the light scanning apparatus, a first secondary scanning range of the first primary scanning lines and a second secondary scanning range of the remaining primary scanning lines at least partially overlap with each other outside the light scanning apparatus.

Preferably, the adjusting member includes: a third optical element configured to refract one or both of the light beams forming the first primary scanning lines and the light beams forming the remaining primary scanning lines so that the first secondary scanning range and the second secondary canning range come closer to each other.

Preferably, a second boundary controller is configured to turn off the light beam during a predetermined period around a boundary between a first period during which the light beam forms the first primary scanning lines and a second period during which the light beam forms the remaining primary scanning lines.

Preferably, the scanning assembly is configured to form the plurality of primary scanning lines parallel to each other by the light beam, the light beam being an intermittently fired light beam, and after being adjusted by the adjusting member, spots formed by the light beam are sparser on the first primary scanning lines than on the remaining primary scanning lines.

Preferably, the light scanning apparatus further includes: an acquiring portion configured to acquire a correspondence between a position of the light beam outgoing from the scanning assembly in the primary scanning direction and an outgoing direction in which the light beam passing through the position is emitted after being adjusted by the adjusting member; and a pulse controller configured to control a firing interval of the light beam based on a position of the light beam presently outgoing from the scanning assembly in the primary scanning direction and the correspondence acquired by the acquiring portion.

Alternatively, the acquiring portion is preferably configured to acquire a correspondence between a position of the light beam outgoing from the scanning assembly in the primary scanning direction and an outgoing direction in which the light beam passing through the position is emitted after being adjusted by the adjusting member, in correspondence with a position of the light beam outgoing from the scanning assembly in the secondary scanning direction; and the pulse controller is configured to control a firing interval of the light beam based on a position of the light beam presently outgoing from the scanning assembly, in the primary scanning direction and the secondary scanning direction, and the correspondence acquired by the acquiring portion.

Preferably, in the light scanning apparatus, the pulse controller is configured to control the firing interval so that the spots formed on the respective primary scanning lines adjusted by the adjusting member are equally spaced.

Preferably, the scanning assembly includes: a first actuator configured to reciprocally rotate a first mirror around a first rotation axis; and a second actuator configured to reciprocally rotate a second mirror around a second rotation axis different from the first rotation axis, wherein the light scanning apparatus is configured to emit the light beam after reflecting the light beam by the first mirror and the second mirror, the primary scanning lines are formed in accordance with change in orientation of the first mirror, and the pulse controller is configured to detect rotation speed of the first mirror and control the firing interval of the light beam based also on the detected rotation speed.

An object detecting apparatus of the present invention includes: any of the above-described light scanning apparatus; a light-receiving element; an optical assembly configured to guide light incident from outside to the light-receiving element along an optical axis same as that of the light beam projected by the light scanning apparatus; and an object detecting assembly configured to detect a distance to an object located along an optical path of the projected light beam and a direction in which the object is located, based on a projection timing and a projection direction of the projected light beam and a timing of a light detection signal output by the light-receiving element. Preferably, the light beam is a laser beam.

The present invention is not limited in the above described embodiments, it can be also performed in other forms such as an apparatus, a system, a method, a program, or a storage medium in which a computer program is stored.

By merits from the configuration described above, it is possible to realize a small and low cost construction to perform wide range scan with a light beam periodically changing light projection direction thereof.

### BRIEF DESCRIPTION OF DRAWINGS

FIG. 1 is a block diagram illustrating principal configuration related with a first embodiment of an object detecting apparatus 10 according to the present invention with focus on the functions thereof.

FIG. 2 is a schematic view showing an optical path of a scan beam L2a passing through prisms 61, 62.

FIG. 3 is a schematic perspective view showing structures of the prisms 61, 62 and a transparent plate 63, and the optical path of the scan beam L2a passing through them.

FIG. 4 is a view illustrating a configuration of scanning lines formed by projected light L2 passing through the prisms 61, 62 and the transparent plate 63.

FIG. 5 is an exploded perspective view of main constituent elements of the object detecting apparatus 10.

FIG. 6 is a schematic cross-sectional view of an actuator 31 at a plane perpendicular to the rotation axis of a mirror 31a and at the position of a core 311 of a coil.

FIG. 7 is a graph illustrating a relationship between scan angle of the mirror 31a and absolute value of scanning angular velocity of the mirror 31a.

FIG. 8 is a chart illustrating an example of a drive signal of an LD module 21.

FIG. 9 is a view illustrating an example of spots on a scanning line formed by the scan beam L2a.

FIG. 10 is a graph illustrating a relationship between propagating direction col of the scan beam L2a reflected by the mirror 31a and incident on the prism 61 or 62 and propagating direction ω2 of the projected light L2 after passing through the prism 61 or 62.

FIG. 11 is a diagram illustrating a configuration of a control circuitry for controlling pulse interval of the drive signal of the LD module 21 with peripheral circuitry.

FIG. 12 is a chart illustrating an example of the drive signal of the LD module 21 generated in the circuitry of FIG. 11;

FIG. 13 is a view illustrating a shape of the prism 61 in a modified example of the first embodiment.

FIG. 14 is a schematic view corresponding to FIG. 2, showing an optical path of the scan beam L2a passing through prisms in the modified example.

FIG. 15 is a perspective view showing a configuration of optical elements constituting the adjusting member 60 in the modified example.

FIG. 16 is a schematic view showing an optical path of scan beam L2a and projected light L2 passing through an adjusting member 60-1 in a second embodiment in the secondary scanning direction.

FIG. 17 is a perspective view showing a configuration of optical elements constituting the adjusting member 60-1 in the second embodiment.

FIG. 18 is a view corresponding to FIG. 4, illustrating an example of scanning lines formed by the projected light L2 in the second embodiment.

FIG. 19 is a schematic view corresponding to FIG. 16, showing an optical path of scan beam L2a and projected light L2 passing through an adjusting member 60-2 different from that of FIG. 16.

FIG. 20 is a perspective view corresponding to FIG. 17, showing a configuration of optical elements in FIG. 19.

FIG. 21 is a schematic view corresponding to FIG. 16, showing an optical path of scan beam L2a and projected light L2 passing through an adjusting member 60-3 different from those of FIG. 16 and FIG. 19.

FIG. 22 is a perspective view corresponding to FIG. 17, showing a configuration of optical elements in FIG. 21.

### DESCRIPTION OF EMBODIMENTS

Embodiments of the present invention will be described with reference to the drawings.

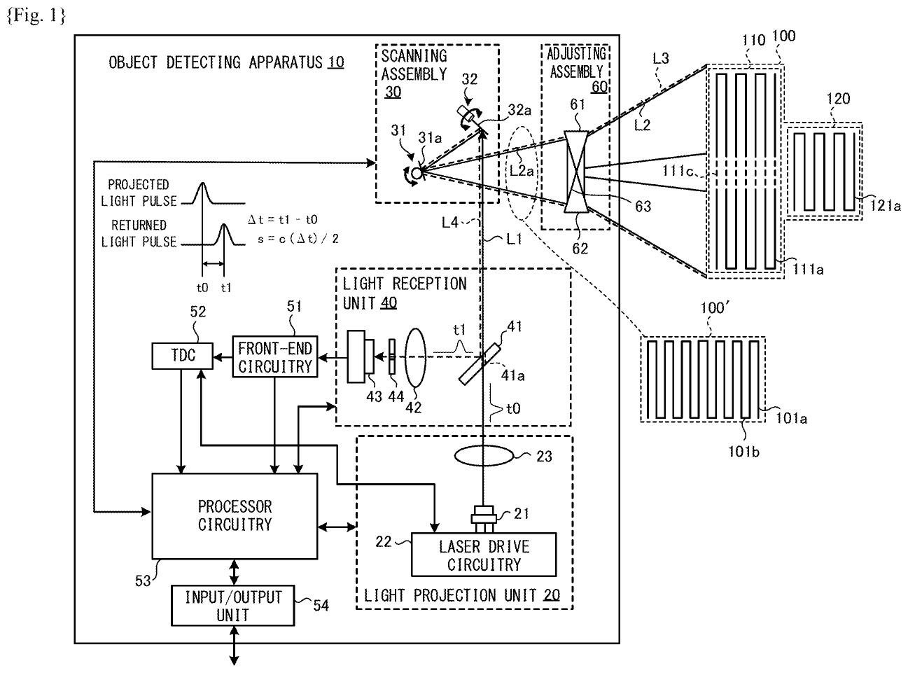

### First Embodiment (FIG. 1 to FIG. 12)

Firstly, overall configuration of an object detecting apparatus 10 according to a first embodiment of the present invention will be described by focusing of functions thereof with reference to FIG. 1. FIG. 1 is a block diagram illustrating principal configuration of the object detecting apparatus focusing on the functions thereof.

The object detecting apparatus 10 projects a laser beam outwards, detects the laser beam which is reflected by an external object and thereafter returned back to the object detecting apparatus 10, thus to detect a distance to the object located along an optical path of the projected laser beam and a direction in which the object is located, based on projection direction of the projected laser beam and the time difference between projection timing of the projected laser beam and detection timing of the reflected laser beam. As shown in FIG. 1, the object detecting apparatus 10 includes a light projection unit 20, a scanning assembly 30, a light reception unit 40, a front-end circuitry 51, a Time-to-Digital Converter (TDC) circuitry 52, a processor circuitry 53, an input/output unit 54, and an adjusting member 60.

The light projection unit 20 is configured to project a laser beam outward, and includes a laser diode module (LD module)21, a laser drive circuitry 22, and a collimating lens assembly 23.

The LD module 21 is a laser light source that emits laser beam based on a drive signal applied from the laser drive circuitry 22. Here, a light source with a plurality of light emitting points is used to improve the optical intensity of the output. Alternatively, a semiconductor laser such as a pulsed laser diode with a stripe structure with a wide light emitting area may also be used in order to improve the optical intensity of the output. The stripe structure functions as an extended light source, and is equivalent to a plurality of physical light emitting points. Instead, the number of light emitting points can also be one point. The wavelength of the laser beam is not particularly specified, for example, near-infrared light is also preferred in the present invention. The laser beam is an exemplary representation of a light beam.

The laser drive circuitry 22 is configured to generate a drive signal for lighting the LD module 21 at a timing based on a parameter supplied by the processor circuitry 53 and apply the drive signal to the LD module 21. The lighting of LD module 21 is modulated in an intermittent operation by pulse signal waveform.

The collimating lens assembly 23 is configured to convert the laser beam output from the LD module 21 into a general collimated light beam. In this embodiment, the collimating lens assembly 23 is a collimator lens with convex shape with its focal point alignment to the center position of the plurality of light-emitting points.

A laser beam L1 formed by the collimating lens assembly 23 passes through a light-transmitting area 41a of a mirror 41 of the light reception unit 40, and is reflected by a mirror 31a and a mirror 32a of the scanning assembly 30 to form a scan beam L2a, then the propagating direction of the scan beam L2a is adjusted by prisms 61, 62 or a transparent plate 63 of the adjusting member 60, and the adjusted beam transmits outward as projected light L2.

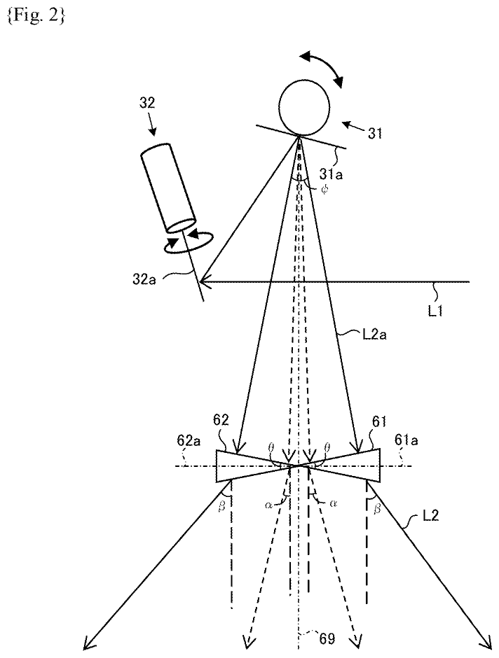

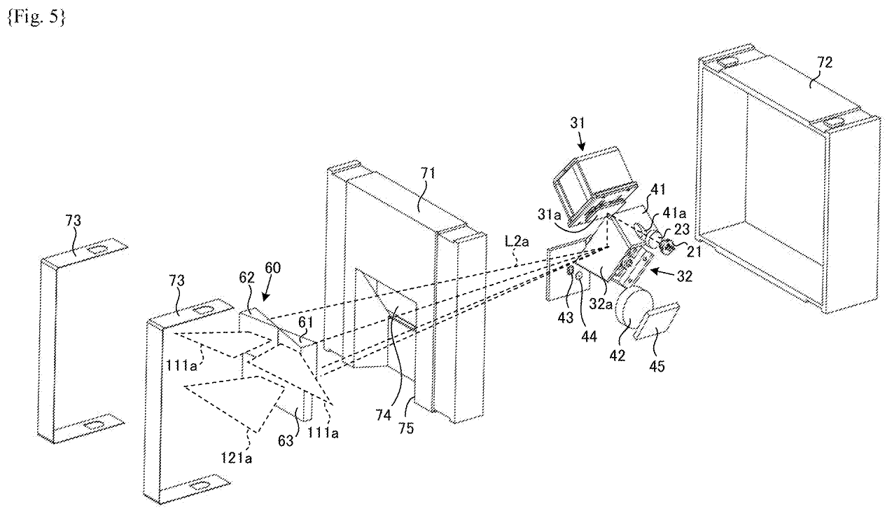

For the intuitive understanding, FIG. 1 and FIG. 2 show the laser beam L1 reflected from the mirror 32a to the mirror 31a, but actually, the laser beam L1 is reflected from the mirror 31a to the mirror 32a as described later with reference to FIG. 5. Anyway, the reflecting order is not essential, and any order is acceptable.

The scanning assembly 30 is configured to deflect the laser beam exiting from the light projection unit 20 and reciprocally scan within a predetermined field of view (FOV) 70. The scanning assembly 30 includes an actuator 31 and an actuator 32.

In this embodiment, the actuator 31 is a representative indicated in Japanese Patent No. 6521551. Specifically, the actuator includes a mirror 31a fixed to one side of a torsion spring having a straight folded peak in such a way that the mirror 31a straddles the folded peak, and the mirror 31a rotates around a rotation axis (first axis) substantially in the center of the folded peak of the torsion spring due to interaction between a permanent magnet and a coil located on the other side of the torsion spring 302, thereby the mirror 31a can oscillate within a predetermined angular range. The actuator 32 is a generally known galvanometer mirror. By applying a force to one end of its axis, the mirror 32a mounted to the other end of the axis rotates around the axis (second axis). However, the structures of the actuators 31, 32 are not limited thereto.

The scanning assembly 30 controls the orientation of the scan beam L2a in a primary scanning direction through adjustment of the orientation of the mirror 31a, and controls the orientation of the scan beam L2a in a secondary scanning direction through adjustment of the orientation of the mirror 32a.

Thereby, the scan beam L2a forms scanning primally scanning (Horizontal) lines 101a within a predetermined angular range 100′ according to the rotation of the mirror 31a, and forms secondary scanning (Vertical) lines 101b according to the rotation of the mirror 32a, and the scanning position in the secondary scanning direction is adjusted.

Note that the lighting of the LD module 21 is modulated in an intermittent operation, the scanning lines 101a, 101b are not continuous lines but appeared as a series of discrete beam spots.

The scan beam L2a is incident on the prism 61 or 62 or the transparent plate 63 of the adjusting member 60 at a position corresponding to the propagating direction thereof, and the propagating direction is adjusted by refraction at the adjusting member 60 to form projected light L2. The projected light L2 forms scanning lines within a predetermined scanning range 100, the predetermined scanning range 100 including a first scanning range 110 with a relatively wide-angle range and a second scanning range 120 with an angle range narrower than the first scanning range 110. The structures and functions of the prisms 61, 62 and the transparent plate 63 and the configuration of the scanning lines will be described later with reference to FIG. 2 to FIG. 4.

The light projection unit 20, the scanning assembly 30 and the adjusting member 60 constitute a light scanning apparatus.

The light reception unit 40 is configured to detect the incident light from the external of the object detecting apparatus 10, and includes a mirror 41, a collective lens 42, a light-receiving element 43, and an aperture 44. The light to be detected by the light reception unit 40 is reflected light of the laser beam projected from the object detecting apparatus 10 and thus returned back to the object detecting apparatus 10. The returned light L3 is the scattered proportion by an object surface reverse to the optical path of the projected laser beam. The returned light L3 thereafter returns back along the retro-reflective direction which is substantially the same but the reverse path to the projected light L2 and reaches the mirror 41 as the returned light L4.

The mirror 41 is a fixed mirror including a light-transmitting area 41a through which the laser beam exiting from the light projection unit 20 passes, and the mirror 41 is configured to guide the returned light L4 to the light-receiving element 43. At the position of the mirror 41, the returned light L4 is occupying much wider area than the laser beam L1, and therefore the proportion of the returned light L4 out of the light-transmitting area 41a is reflected toward the light-receiving element 43.

The collective lens 42 is a convex optical member configured to collect the returned light L4 reflected by the mirror 41 on a specified focal plane.

The light-receiving element 43 is a light detecting element that outputs a detection signal corresponding to the intensity of light falling on its light-receiving surface. The light-receiving element may be, for example, a silicon photomultiplier (SiPM), but is not limited thereto.

The aperture 44 is disposed on the focal plane of the collective lens 42, and blocks light falling on the area out of an opening area thereof to prevent interference light from falling on the light-receiving element 43.

The mirror 41, the collective lens 42 and the aperture 44 constitute a light-receiving optical assembly.

The front-end circuitry 51 shapes the detection signal output by the light-receiving element 43 into a waveform suitable for timing detection in a TDC circuitry 52.

The TDC circuitry 52 generates a digital output representative of a time delay between timing t0 of a lighting pulse of the laser beam L1 and timing t1 of an output pulse of the returned light L4 corresponding thereto, based on the drive signal applied to the laser drive circuitry 22 and the detection signal after processed by the front-end circuit 51.

Between a pulse of the projected light and a pulse of the returned light, the time delay occurs when the projected light reaches the object along the optical path and returns to the object detecting apparatus 10. Thus, based on the time delay Δt, a distance s from the apparatus 10 to the object can be calculated as

s=c·(Δt)/2,

where c is the velocity of light. More accurately speaking, s is the length of the optical path from the object to the light-receiving element 43.

The processor circuitry 53 is configured to control the operations of the configurations illustrated in FIG. 1. The processor circuitry 53 may be constructed by a general-purpose computer which comprises CPU, ROM, RAM and so on and executes software, or by a specific hardware configuration, or by the combination of them. The processor circuitry 53 performs, for example, the calculation of the distance to the object based on the output signal from the TDC circuitry 52, and the calculation of the direction in which the object is located based on the timing of scan of the scanning assembly 30 (the direction of the projected light L2) at a time when detecting the returned light. As the detailed description in the succeeding paragraphs, the processor circuitry 53 also performs the control of the pulse interval of lighting of the LD module 21 based on the orientation of the mirror assemblies 31a, 32a in the scanning assembly 30.

The input/output unit 54 is configured to input/output information from/to peripherals. The input/output of the information mentioned herein includes such operations of wired or wireless communication with peripheral apparatus, receipt of user operations with buttons, touch panels or the like, and indication to users with displays, lamps, buzzers, vibrators or the like. The information output from the input/output unit 54 might be the information related to the detected object (for example, raw data of the distance and/or direction, or furtherly the information indicating the specific size, the position, the moving speed or the like based thereon), or that information related to operation status or setting status of the object detecting apparatus 10. The information input by the input/output unit 54 might be, for example, the information related to the operation settings of the object detecting apparatus 10.

The communication counterpart of the input/output unit 54 might be, for example, a vehicle with autonomous driving function or a mobility object such as a drone device. With supplied information of the object detected by the object detecting apparatus 10, an autonomous driving system might make plan of driving route so as to avoid collisions to the detected object based on such information.

It is also preferred to implement the object detecting apparatus 10 to be a system coupled with its communication counterpart such as a vehicle, a drone, an aircraft or the like.

The structures and functions of the prisms 61, 62 and the transparent plate 63 and the configuration of scanning lines formed by the projected light L2 will be described with reference to FIG. 2 to FIG. 4.

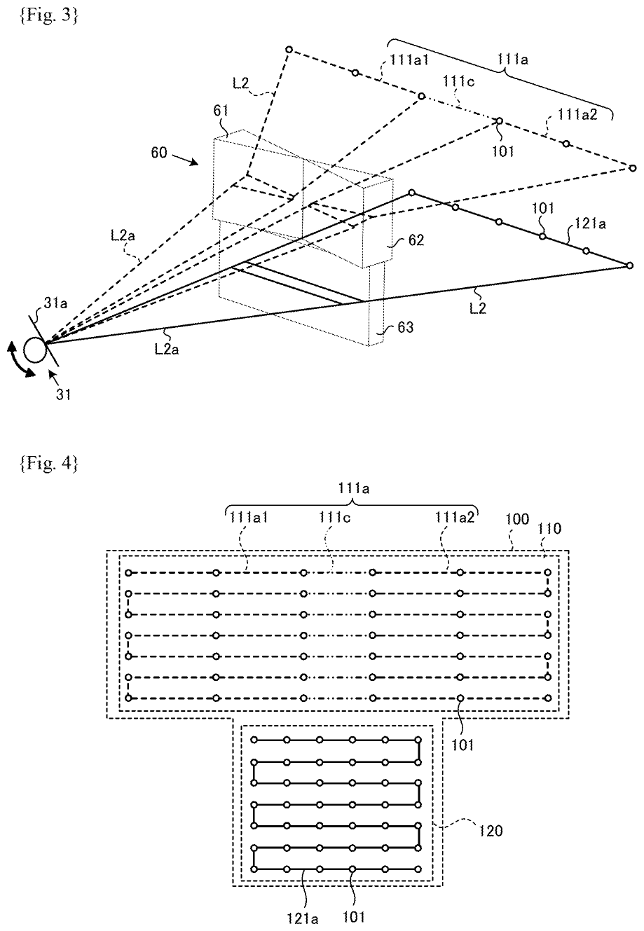

FIG. 2 is a schematic view showing the optical path of the scan beam L2a passing through prisms 61, 62. FIG. 3 is a schematic perspective view showing structures of the prisms 61, 62 and a transparent plate 63, and the optical path of the scan beam L2a passing through them. FIG. 4 is a view illustrating a configuration of the scanning lines formed by the projected light L2 passing through the prisms 61, 62 and the transparent plate 63. Note that the mirror 32a is omitted in FIG. 3 and the optical path after the mirror 31a is shown. In FIG. 3 and FIG. 4, the optical paths and scanning lines passing through the prisms 61, 62 are indicated by broken lines, and the optical paths and scanning lines passing through the transparent plate 63 are indicated by solid lines.

As shown in FIG. 2, the actuator 32 is configured to reciprocally rotate the mirror 32a and reflects the laser beam L1 on the mirror 32a, thereby forming a scan beam L2a within a scan angle ψ in the primary scanning direction. The position of the scan beam L2a in the secondary scanning direction is adjusted by orientation of the mirror 31a, but the scan angle Ψ is constant, irrespective of the position in the secondary scanning direction.

On the other hand, at least the surface on which the scan beam L2a is incident on the respective prisms 61, 62 and the surface through which the projected light L2 is emitted are planar, and these surfaces form an apex angle θ. In this embodiment, for convenience of explanation, an example in which the boundary between the prism 61 and 62 is located at the midpoint of the scan angle Ψ and the prisms 61, 62 are symmetric about the surface 69 is described, the surface 69 passing through the position where the mirror 31a reflects the laser beam L1 and the boundary between the prism 61 and 62. However, such configuration is not essential.

The prism 61 is a first optical element disposed on a first end side (the right side in FIG. 2) of the primary scanning lines of the scan beam L2a. The prism 61 is configured and placed such that the beam incident on the prism 61 within a first primary scanning range is the more strongly refracted to a direction of the first end of the primary scanning line at the closer positions to the first end, due to the incident angle of the scan beam L2a varying with the incident position in the primary scanning direction.

The prism 62 is a second optical element disposed on the other second edge side (the left side in FIG. 2) of the primary scanning lines of the scan beam L2a. The prism 62 is configured and placed such that the beam incident on the prism 62 within a second primary scanning range is the more strongly refracted to a direction of the second end of the primary scanning line at the closer positions to the second end, due to the incident angle of the scan beam L2a varying with the incident position in the primary scanning direction.

In FIGS. 2, α and β mean inclination angles of the optical paths of the projected light L2 passing through the prisms 61, 62 relative to the optical paths (surface 69) passing through the boundary between the prisms 61, 62. It can be seen from FIG. 2 that the projected light L2 scans a range of scan angle of about 2β.

For example, if the prisms 61, 62 having the refractive index nd=1.8 and the apex angle θ=23° are used, the maximum scan angle of about 100° can be realized as the scan angle 2β of the projected light L2, relative to the scan angle ω=45° of the scan beam L2a (the rotation angle of the mirror 31a). That is, an extended angle range about twice the rotatable range of the actuator 31 can be achieved.

The actuator 31 using the torsion spring is favorable to be compact size and can rotate at high speed. However, due to the limit of the movable range of the torsion spring, the rotation angle cannot become too large. In this method, much wider scanning range exceeding to the mechanical scanning limitation can be achieved by implementing the prisms 61, 62.

Alternatively, the prisms 61, 62 is not necessarily arranged so that both the symmetry axis 61a of the prism 61 and the symmetry axis 62a of the prism 62 are located along one straight line, and the symmetry axes 61a, 62a are not necessarily orthogonal to the surface 69. The incident side of the scan beam L2a may be narrower or wider than the outgoing side of the projected light L2. Even if the ω value is the same, the values of α and β can vary based on the orientations of the prisms 61, 62. Of course, the relationship between ω and α or β varies with the refractive index nd and the apex angle θ of the prisms.

In FIG. 2, the prism 61 refracts the scan beam L2a to the right, and the prism 62 refracts the scan beam L2a to the left, when the scan beam L2a passes around the boundary between the prism 61 and the prism 62, the propagating direction of the projected light L2 changes abruptly. The scan beam L2a may be irregularly scattered at the boundary between the prism 61 and the prism 62.

In consideration of this point, to avoid optical noise caused by such irregularity during scanning, the object detecting apparatus 10 turns off the LD module 21 while the scan beam L2a passes through the boundary between the prism 61 and the prism 62, for example, the area between the two dotted light paths in FIG. 2.

As shown in FIG. 3 and FIG. 4, in the primary scanning lines 111a formed in the first scanning range 110 by the projected light L2 passing through the prisms 61, 62, a gap is formed within a range of about 2α scan angle near the center of the scanning range of the primary scanning lines 111a, between a first portion of primary scanning lines 111a1 formed by the beam passing through the prism 61 and a second portion of primary scanning lines 111a2 formed by the beam passing through the prism 62, and the gap forms a dead zone 111c where cannot be scanned.

In the object detecting apparatus 10, a transparent plate 63 is disposed in the secondary scanning range of the scan beam L2a in order to alleviate the influence of the dead zone 111c.

The transparent plate 63 does not have refractive power of changing direction of incident light, so it allows the scan beam L2a to pass through without changing its direction and then to emit outwards as projected light L2. Through the projected light L2, in the second scanning range 120, primary scanning lines 121a are formed in the same range of scan angle ω as that of the scanning range 100′, therefore no dead zone is formed near the center of the primary scanning lines 121a. The primary scanning lines 121a preferably has a primary scanning direction range covering at least the dead zone 111c of the primary scanning direction range.

If considering the entire scanning range 100, the overall much wider scan angle of the first scanning range 110 can be achieved at any position in the secondary scanning direction due to the primary scanning lines 121a as well as the primary scanning lines 111a. In the cases where a long object in the secondary scanning direction is scanned, an object with larger size than the scanning range 100 is detected. As long as the position of the object in the primary scanning direction can be covered by part of scanning lines in the secondary scanning direction, the detection can be conducted without any difficulty. Even if the dead zone 111c exists and the scan angle is narrow in the second scanning range 120, the detection can also be implemented, and the merit of the wide scanning range of about 2β as an overall range can be achieved, for example, in the application where the goal is to only detect large objects to avoid collision without too much care of small objects.

Meanwhile, the scan beam L2a passes through the vicinities of the boundaries between the prisms 61,62 and the transparent plate 63, the object detecting apparatus 10 turns off the LD module 21 for the same reason around the boundary between the prism 61 and the prism 62. Alternatively, in the vicinity of the boundary, the object detecting apparatus 10 accelerates the rotation of the actuator 32 for each scanning line to skip the boundary. Anyway, a blank zone in certain extent in the secondary scanning direction will be formed between the first scanning range 110 and the second scanning range 120.

In the object detecting apparatus 10, as shown in FIG. 4, spots 101 formed on the primary scanning lines are sparser in the first scanning range 110 than in the second scanning range 120. The first scanning range 110 has a larger angle range in the primary scanning direction than the second scanning range 120. Therefore, if it is required that the spots 101 are to be configured at the same density, the firing interval should be shorter and it needs to increase the repentant frequency of lighting control. For the consideration to make a compact apparatus 10, if the repentant frequency of lighting control is increased, it needs to consider extra space for heat dissipation. Certainly the lifespan of the LD module 21, the eye safety issue of the outgoing laser and the like should also be considered. To avoid these problems, the lighting cycle of the LD module 21 in the first scanning range 110 is preferred to be set to the same as that in the second scanning range 120. If such sparse distribution of the spots 101 is acceptable, a smaller, safer and much reliable optical scanning performance can be achieved.

As for the adjusting member 60, since the transparent plate 63 has no optical power, it can also be ignored. It might also be preferred that the prisms 61, 62 are disposed over the entire range in the secondary scanning direction. In this configuration, the primary scanning range of the dead zone 111c will not be compensated by the primary scanning lines 121a. However, in the case where scanning within part of range in the primary scanning direction can be ignored without substantial disadvantage, the merit of extended scanning range can also be achieved in this configuration.

The implement of the two prisms 61, 62 is not essential. Single prism covering the entire incident range of the scan beam L2a in the primary scanning direction may also be acceptable. The extended scanning range will become limited compared with the case of using double prisms 61, 62. Because the difference between the incident and outgoing angles is produced by refraction varying with the incident angle of the beam, the scanning range of the projected light L2 is extended compared with the scan beam L2a result of such variation of the angle difference. Certainly, in such case single prism is used, no any dead zone is formed.

Furtherly, instead of the prisms 61, 62, a concave lens with at least a curved surface is also adopted where the scan beam L2a is incident to the curved surface and the outgoing projected light L2 is emitted from another surface. Similar to the embodiment with double prisms 61, 62, the propagating direction of the scan beam L2a and the overall scanning range of the projected light L2 can also be extended. The disadvantage of this embodiment is that when the beam passes through the curved surface, aberration occurs and spots 101 become blurred, so it becomes more difficult to detect the returned light. The aberration might be corrected by combining a plurality of lenses, but it will result to an increased size and the manufacturing cost. However, if such disadvantage can be ignored, a concave lens may also be preferable. When the beam passes through the planar surface of the prisms 61, 62, no aberration will occur and the problem mentioned above is not existed.

The structure of the object detecting apparatus 10 is outlined with reference to FIG. 5. FIG. 5 is an exploded perspective view of main constituent elements of the object detecting apparatus 10.

As shown in FIG. 5, the object detecting apparatus 10 is provided with a housing formed by combining a top cover 71 and a rear cover 72 through two cover clips 73, 73. The top cover 71 is provided with a window through which the scan beam L2a passes, and a protective material 74 is embedded into the window that prevents intrusion of dust and it is transparent to the wavelength of the scan beam L2a.

The adjusting member 60 is mounted in a cavity member 75 which is located outside the window, and the adjusting member 60 is an optical member including the prisms 61, 62 and the transparent plate 63 which are integrally formed as a single unit. The scan beam L2a passing through the window further passes through the adjusting member 60, thereby forming the projected light L2 including the primary scanning lines 111a, 121a. The adjusting member 60 may be fixed to the top cover 71 by adhesion or the like, or may be detachable from the top cover 71. If it is detachable, the adjusting member 60 can be mounted when a large scanning range is preferred, and the adjusting member 60 can be detached when scanning without a dead zone 111c is preferred, so that the scanning range can be changed easily.

The respective constituent elements shown in FIG. 1 other than the adjusting member 60 are implemented inside the housing. The mirror 45, not shown in FIG. 1, is an optical element between the mirror 41 and the collective lens 42 for changing the direction of the returned light L4. The circuitries of the laser drive circuitry 22, the processor circuitry 53, and the like, or the wires between the mentioned assembly/units are not shown in FIG. 5 to simplify the drawing.

The detailed structure of the actuator 31 will be described with reference to FIG. 6.

FIG. 6 is a schematic cross-sectional view of the actuator 31 at a plane perpendicular to the rotation axis of the mirror 31a and at the position of a core 311 of a coil.

As shown in FIG. 6, in the actuator 31, the mirror 31a is fixed to one side of the torsion spring 302 with a straight folded peak 302c and planar-shaped arms 302b through a holder 323 in such a way that the mirror 31a straddles the folded peak 302c. Planar-shaped arms 302a at the end (the back side in FIG. 6 and the front side not shown in the figure) of the torsion spring 302 is fixed to a top yoke 314 as a support member. A permanent magnet 321 is fixed to the other side of the torsion spring 302, and the permanent magnet 321 is disposed such that its N pole 321n and S pole 321s are located at the separated sides across the folded peak 302c.

A driving coil 316 is wound on a core 311 made of a ferromagnetic body so that one end of the driving coil is opposite to the permanent magnet 321. A sensing coil 317 is also wound on the same core 311. The frame yoke 312 and the top yoke 314 made by a magnetic substance form a wall structure surrounding the coil. A terminal for applying a drive signal to the driving coil 316 and a terminal for outputting a signal generated in the sensing coil 317 are disposed at the positions not covered by the magnetic wall.

When the driving coil 316 is powered on and thus, for example, the end thereof facing the permanent magnet 321 becomes an N pole, the S pole 321s of the permanent magnet 321 is attracted by the driving coil 316. Accordingly, the torsion spring 302 is rotated and twisted clockwise around a rotation axis 304, and the mirror 31a is also rotated clockwise around the rotation axis 304. The rotation is stopped at a position where the magnetic force generated between the driving coil 316 and the permanent magnet 321 is balanced with the restoring force of the torsion spring 302. The speed and stop position of the rotation can be adjusted by changing the intensity of current flowing through the driving coil 316. When the driving coil 316 is reversely powered on, the torsion spring 302 and the mirror 31a are rotated counterclockwise similarly.

By periodically alternating the direction of voltage or current of the drive signal applied to the driving coil 316, as shown by arrows V in FIG. 6, the mirror 31a is alternately rotated clockwise and counterclockwise, and can thus reciprocate (oscillate) around the rotation axis 304 within a predetermined angular range.

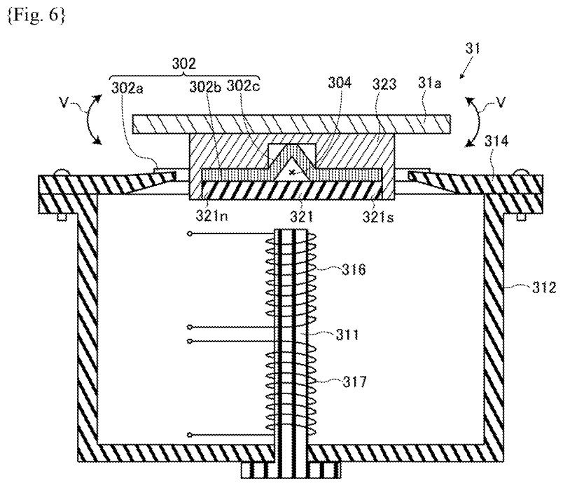

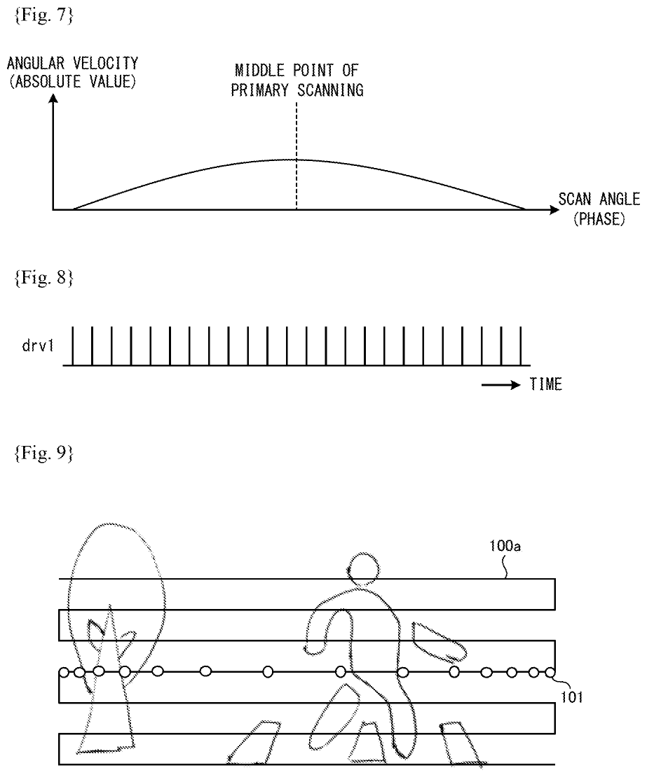

The characteristics of oscillation of the mirror 31a by the actuator 31 will be described with reference to FIG. 7 to FIG. 9. FIG. 7 is a graph illustrating a relationship between scan angle of the mirror 31a and absolute value of scanning angular velocity of the mirror 31a, FIG. 8 is a chart illustrating an example of the drive signal of the LD module 21, and FIG. 9 is a view illustrating an example of spots on the scanning line formed by the scan beam L2a.

It is found by the inventor through the experiment that the moving speed of the mirror 31a oscillated by the actuator 31 is not constant. Since the mirror 301a stops at the end of the oscillation path and moves in the other portions, it is obvious that the moving speed changes. As indicated in FIG. 7, the speed generally becomes lower as it moves forward to the end points of the oscillation path and becomes higher as it moves backward to the middle point. The speed is almost equal at the same position regardless of the direction of the rotational movement, that is, clockwise or counterclockwise, the only difference is the direction of the movement.

Herein FIG. 7 illustrates the variation of the moving speed along the oscillation path. In FIG. 7, the position along the oscillation path (described as rotation angle, and can be called a “scan angle”) is plotted as the horizontal axis and the absolute value of the angular velocity corresponding to that position is plotted as the vertical axis.

Since the rotation speed of the mirror 31a varies as illustrated in FIG. 7, when the LD module 21 is driven by a drive signal drv1 with an equal pulse interval as illustrated in FIG. 8, the temporal distribution of the spots 101 of the scan beam L2a along the scan line 100a will be formed as illustrated in FIG. 9. That is to say, the spots are temporally distributed with large spatial intervals around the middle portion of the scan line but with small spatial intervals around the end portions along the primary scan direction. Therefore, the detection resolution of object is lower in the middle portion than that in the end portions.

For the projected light L2 passing through the transparent plate 63, the distribution of spots on the scanning lines 121a is the same as that of FIG. 9, but the distribution of spots by the projected light L2 passing through the prisms 61, 62 is affected by the prisms 61, 62.

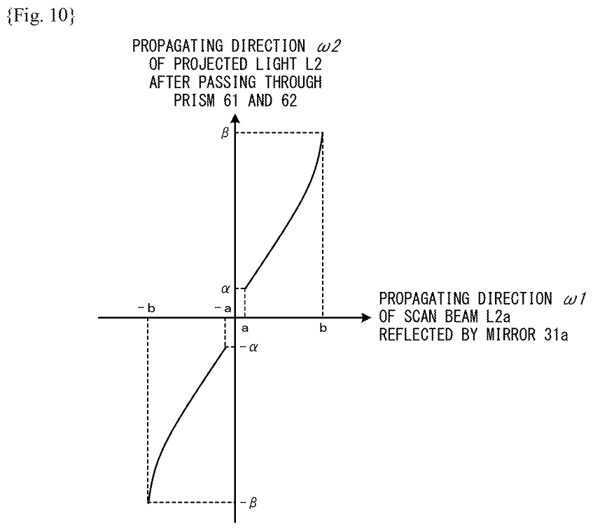

FIG. 10 illustrates a relationship between the propagating direction ω1 of the scan beam L2a reflected by the mirror 31a and incident on the prism 61 or 62 and the propagating direction ω2 of the projected light L2 after passing through the prism 61 or 62. The values of the respective axes are angles between the surface 69 in FIG. 2 and ω1 and between the surface 69 and ω2. The counterclockwise direction seen from the surface 69 is positive.

In FIG. 10, the portion where both ω1 and ω2 are positive corresponds to the beam passing through the prism 61, and the portion where both ω1 and ω2 are negative corresponds to the beam passing through the prism 62. The points where the absolute value of ω1 is at the maximum corresponds to the ends of the scan beam L2a in the primary scanning direction, and the portion where the lines are interrupted near ω1=0 corresponds to the dead zone 111c in the center of the primary scanning direction. In addition, the propagating direction ω2 of the projected light L2 at each time point is a value obtained by converting the direction of ω1 determined by the angle of the mirror 31a at that time point according to the relationship shown in FIG. 10.

The relationship between ω1 and ω2 varies with the refractive index nd, the apex angle θ, and the arrangement angle of the prisms 61, 62, and so on, and is generally not a simple linear relationship as shown in FIG. 10. In this embodiment, the change rate of ω2 is greater than that of ω1, and further, the larger the absolute value of ω1 (the closer to the end in the primary scanning direction), the larger the change rate of ω2 is.

The relationship between ω1 and ω2 can be measured and determined in advance. Therefore, if the relationship between ω1 and ω2 obtained by the measurement or its approximate expression is stored in certain memory in advance so that the control circuitry can refer it, and the control circuitry can obtain the value of ω1 in real time, the object detecting apparatus 10 can obtain the value of ω2 in real time during the scanning process.

The object detecting apparatus 10 has a function of controlling the pulse interval of the drive signal of the LD module 21 in consideration of the characteristics of oscillation by the actuator 31 and the characteristics of the prisms 61, 62 such that the spots 101 formed by the projected light L2 are distributed at equal spatial intervals on the each primary scanning lines 111a, 121a. Note that the intervals of the spots 101 on the primary scanning lines 111a and those on the primary scanning lines 121a may be different, as described above.

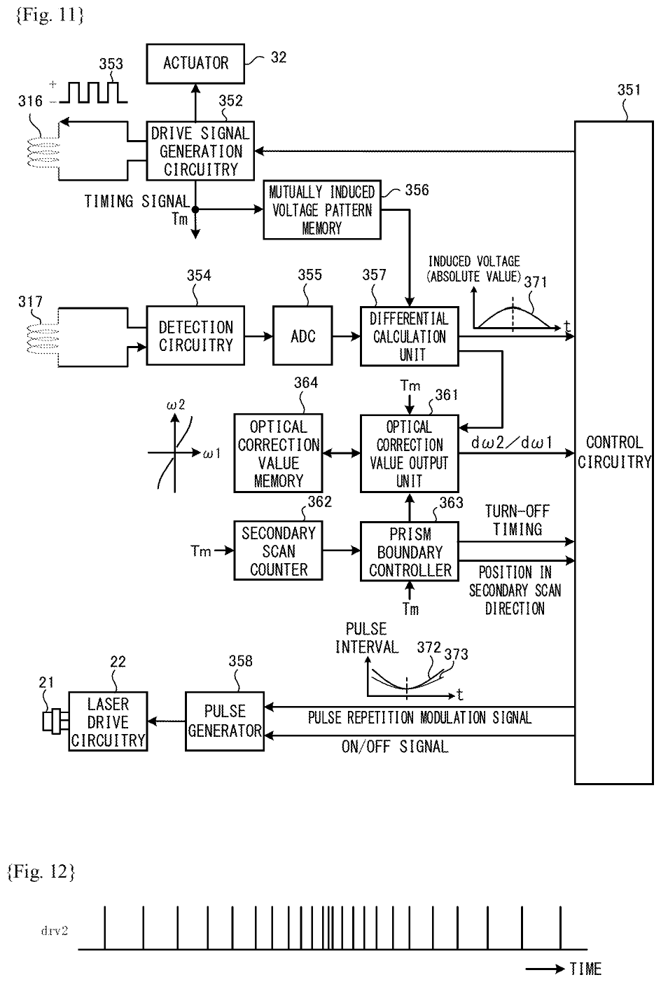

The operation and function of the control circuitry that performs this control will be described with reference to FIG. 11. FIG. 11 illustrates a configuration of the control circuitry with surrounding circuits.

The control circuitry 351 shown in FIG. 11 corresponds to a pulse controller, and the frequency control with the control circuitry 351 illustrated in FIG. 11 can be roughly divided to three operations: driving control of the actuators 31, 32, detection of rotation speed of the mirror 31a, and control of the firing interval of the LD module 21.

Firstly, regarding the driving control of the actuators 31, 32, the control circuitry 351 sets target values of the scan range and the period of scan to be performed by the actuator 31 through a drive signal generation circuitry 352. The drive signal generation circuitry 352 generates, according to the preset values, a drive signal 353 at an appropriate level of voltage varying in an appropriate cycle, and applies the drive signal 353 to the driving coil 316 of the actuator 31. Thereby, the actuator 31 oscillates the mirror 31a as described with reference to FIG. 6.

The control circuitry 351 generates a drive signal for rotating the actuator 32 in the secondary scanning direction by an angle corresponding to an interval between the neighboring primary scanning lines at timings when the actuator 31 reaches any of the ends of the oscillation range, and outputs the drive signal to the actuator 32. When the actuator 32 reaches any of the ends in the secondary scanning direction, the control circuitry 351 reverses the rotation direction of the actuator 32 to perform scanning of next frame. In this case, the mirror 32a performs reciprocating rotation.

Then, regarding to the detection of rotation speed of the mirror 31a, a detection circuitry 354 detects induced voltage generated in the sensing coil 317 of the actuator 31, an ADC (analog-to-digital converter) 355 converts the voltage into a digital value in real time, and a differential calculation unit 357 corrects the digital value and provides the corrected value to the control circuitry 351. The control circuitry 351 calculates the rotation speed of the mirror 31a based on the provided voltage value. The sensing coil 317 preferably has the same number of turns as the driving coil 316 and wound in reverse direction to the driving coil 316, but other windings can also be accepted.

When the mirror 31a is oscillated, an induced electromotive force caused by two factors is generated in the sensing coil 317.

The first factor is the induced electromotive force generated due to the changes in intensity and direction of the magnetic field generated by the driving coil 316 because of the change in voltage of the drive signal applied to the driving coil 316.

The second factor is the induced electromotive force caused by the change in intensity of the magnetic field due to the oscillation of the permanent magnet 321. When the permanent magnet 321 is oscillated as described with reference to FIG. 6 or the like, the change rate of the intensity of the magnetic field generated in the sensing coil 317 can be considered to be substantially proportional to the rotation angular velocity of the permanent magnet 321. Since the rotation angular velocity of the permanent magnet 321 is the rotation angular velocity of the mirror 31a, the intensity of the induced electromotive force generated by the second factor can be considered to be proportional to the rotation angular velocity of the mirror 31a.

The mutually induced voltage pattern memory 356 and the differential calculation unit 357 are provided to subtract the value of the induced electromotive force caused by the first factor from the output of the ADC 355.

That is, the mutually induced voltage mode memory 356 stores the variation of the voltage value of the induced voltage generated in the sensing coil 317 due to mutual induction when the drive signal is applied to the driving coil 316 in the actuator 31 while the permanent magnet 321 is removed, to correspond to the phase of the drive signal, for a cycle of the drive signal. When applying a drive signal to the driving coil 316 in order to oscillate the mirror 31a, the drive signal generation circuitry 352 provides a timing signal Tm denoting the phase of the drive signal to the mutually induced voltage pattern memory 356. The mutual inductance voltage mode pattern memory 356 provides the stored voltage value corresponding to the current time to the differential calculation unit 357 based on the timing signal Tm.

The differential calculation unit 357 subtracts the voltage value provided by the mutually induced voltage pattern memory 356, as a contribution amount of mutual inductance, from the value of the induced voltage actually generated in the sensing coil 317, provided by the ADC 355. The differential calculation unit 357 provides the difference to the control circuitry 351.

Thereby, the value of induced voltage proportional to the rotation angular velocity of the mirror 31a can be input to the control circuitry 351. If the induced voltage input to the control circuitry 351 is plotted in graph 371 where the horizontal axis indicates the half period from one end to another end of the oscillation range of the mirror 31a, it is the similar distribution to that of the angular velocity illustrated in FIG. 7.

The control circuitry 351 multiplies the voltage value VR(t) provided by the differential calculation unit 357 at the time t by a preset constant K to obtain the angular velocity ω(t) of the mirror 31a according to ω(t)=K×VR(t).

The preset value of K is determined, for example, through the rotation angle of the mirror 31a for the entire half period measured by other experimental method and an integral value of the voltage value VR(t) corresponding to the same half period.

When the current value due to the induced voltage generated in the sensing coil 317 is used, ω(t) can be obtained in the same manner

Next, regarding to the control of the firing interval of the LD module 21, the control circuitry 351 performs the control based on the ω(t), also referring to the correction value based on the characteristics of the prisms 61, 62 as described in FIG. 10.

An optical correction value output unit 361 outputs the correction value. Specifically, the optical correction value output unit 361 calculates the current position of the scan beam L2a in the primary scanning direction as the current angle ω1 of the mirror 31a, calculates the current ratio of the variation of ω2 to the variation of ω1, that is dω2/dω1, according to the calculated current position and the relationship shown in FIG. 10, and outputs the calculated ratio as the correction value. The relationship between ω1 and ω2 varies depending on whether the current scan beam L2a is incident on the prisms 61, 62 or the transparent plate 63 (ω1=ω2 while being incident on the transparent plate 63), and therefore the optical correction value output unit 361 outputs the correction value based also on the current position of the scan beam L2a in the secondary scanning direction.

The drive signal generation circuitry 352 can obtain the current position in the primary scanning direction by integrating the ω(t) output by the differential calculation unit 357 based on the timing signal Tm. That is, since the displacement from the position at the previous timing can be obtained based on the angular velocity ω(t) at every timing of the timing signal Tm, starting from an end of the primary scanning direction, the current position at each timing can be obtained by adding each obtained displacement. If such calculation is performed over a plurality of cycles of scanning in the primary scanning direction, an estimated value of the current position at each timing in one cycle of primary scanning can be obtained. Therefore, the estimated value may be obtained first, and based on a phase indicated by the timing signal Tm, the estimated value corresponding to the phase may be used as the current position while the scanning condition is kept.

The current position in the secondary scanning direction corresponds to the rotation position of the mirror 32a, and can be obtained by counting the number of primary scans based on the timing signal Tm since the number of primary scanning lines per scan of the entire scanning range 100 is known. A secondary scanning counter 362 counts the number of primary scans, and outputs the current position in the secondary scanning direction to a prism boundary controller 363 based on the number.

The prism boundary controller 363 outputs a signal indicating whether the scan beam L2a is presently incident on the prisms 61, 62 or the transparent plate 63 to the optical correction value output unit 361 and the control circuitry 351 based on the current position in the secondary scanning direction. Further, the prism boundary controller 363 detects, based on the current position in the secondary scanning direction and the phase indicated by the timing signal Tm, the timing when the scan beam L2a should be turned off, that is, the timing when the scan beam L2a is incident on the vicinity of the boundary between the prism 61 and the prism 62 or the boundary between the prisms 61, 62 and the transparent plate 63, and outputs a signal indicating the timing to the control circuitry 351.

An optical correction amount memory 364 stores the relationship between ω1 and ω2 shown in FIG. 10 in the form of a table or a conversion expression or the like in advance. This relationship may be stored in correspondence with the position of the scan beam L2a in the secondary scanning direction.

The optical correction value output unit 361 acquires, based on the signal from the prism boundary controller 363, the relationship between ω1 and ω2 corresponding to the current position of the scan beam L2a in the secondary scanning direction from the optical correction amount memory 364, calculates dω2/dω1 based on the acquired relationship and the current position in the primary scanning direction, and outputs the calculated dω2/dω1 to the control circuitry 351.

The relationship between ω1 and dω2/dω1 may be calculated in advance and stored in the optical correction amount memory 364. Alternatively, according to graph 371, if the approximate phase (first half or second half) in one cycle of primary scan is determined, ω(t) corresponds with ω1 one by one. Accordingly, relationship between ω(t) and ω2 or relationship between ω(t) and dω2/dω1 can also be calculated in advance and stored in the optical correction amount memory 364. In this case, even if the optical correction value output unit 361 does not calculate the ω1 at each timing, dω2/dω1 can be obtained according to the timing signal Tm and the current value of ω(t).

Whichever method is used, it is substantially common to obtain the value of dω2/dω1 for controlling the firing interval of the LD module 21 based on the characteristics of the adjusting member 60 corresponding to the current position of the scan beam L2a in the primary scanning direction and the secondary scanning direction, and on the relationship between the propagating direction of the scan beam L2a at the current position and the propagating direction of the projected light L2.

The control circuitry 351 can calculate, by using the ω(t) and dω2/dω1 above, the firing interval T for lighting the LD module 21 at an interval to obtain a desired resolution on the primary scanning lines 111a, 121a of the projected light L2. T=π·(ξ/180)/ω(t)/(dω2/dω1), where the resolution is ξ degrees.

In order to control the firing interval of the LD module 21, the control circuitry 351 calculates the firing interval Tin real time in response to input of the voltage value VR(t) (or ω(t) by the differential calculation unit 357 and input of dω2/dω1 by the optical correction value output unit 361, and provides a pulse repetition modulation signal indicating the value of T to a pulse generator 358. As described above, the resolution can be changed between on the primary scanning lines 111a and on the primary scanning lines 121a. In this case, when the firing interval T is calculated, the value of 86 corresponding to the information about the position in the secondary scanning direction input by the prism boundary controller 363 can be used.

The pulse generator 358 performs pulse repetition modulation according to the pulse repetition modulation signal to generate a timing signal with a pulse of the interval T, and provides the timing signal to the laser drive circuitry 22. The laser drive circuitry 22 generates a drive signal for lighting the LD module 21 at the time of the pulse included in the timing signal provided by the pulse generator 358, and provides the drive signal to the LD module 21.

The control circuitry 351 further outputs an ON/OFF signal for controlling ON/OFF of the lighting of the LD module 21 to the pulse generator 358 based on a turn-off timing signal input by the prism boundary controller 363. The pulse generator 358 turns off, based on the ON/OFF signal, the drive signal while the LD module 21 should be turned off The control for turning off the LD module 21 around the boundary between the prism 61 and the prism 62 corresponds to a control by a first boundary controller, and the control for turning off the LD module 21 around the boundary between the prisms 61, 62 and the transparent plate 63 corresponds to a control by a second boundary controller.

Same as graph 371, we plot the calculated pulse interval output to the pulse generator 358 in the graph 373 with the horizontal axis indicating one period time of the oscillation of the mirror 31a which is from one end to another end of the oscillation range. The graph 372 is the same plot in the case where the change (i.e., dω2/dω1) in the optical path caused by the adjusting member 60 is not considered in the control of the pulse interval.

In graph 372, the control circuitry 351 controls, according to the induced voltage generated in the sensing coil 317, the firing interval of the LD module 21 such that the firing interval is shorter in the case where the mirror 31a is near the center of the oscillating path and the induced voltage is at a high level (first level), compared with the case where the mirror 31a is near any of the ends of the oscillation path and the induced voltage is at a low level (second level).

In graph 373, in addition to the case of the graph 372, the control circuitry 351 controls the firing interval of the LD module 21 so that the firing interval is shorter in the case where the mirror 31a is near any of the ends of the oscillation path and the change in the optical path caused by the refraction of the prisms 61, 62 is large, compared with the case where the mirror 31a is near the center of the oscillation path and the change in the optical path caused by the refraction of the prisms 61, 62 is small.

As a result, as indicated by the symbol drv2 illustrated in FIG. 12, the drive signal of the LD module 21 output by the laser drive circuitry 22 is characteristic with non-equal pulse intervals corresponding to the moving speed of the position of the mirror 31a. Spots 101 formed by deflecting the lighting-controlled laser beam L1 by the mirrors 31a, 32a and further refracting the beam by the adjusting member 60 are arranged to be generally equally spaced over the entire length of the scanning lines 111a (except the dead zone 111c) in the primary scanning direction as shown in FIG. 4. Thus, the object detecting apparatus 10 can detect the object with substantially equal resolution within each area scanned by the primary scanning lines 111a, 121a.

In addition, when it is desired to scan the vicinity of the center in the field of view at a high density, by adjusting the value of according to the position of the scan beam L2a in the primary scanning direction calculated by the optical correction value output unit 361, the distribution density of the spots 101 can be changed based on position in the primary scanning direction.

Regarding to the secondary scanning direction, the mirror 32a is stationary during the scanning of one line in the primary scanning direction, and the adjusting member 60 does not change the orientation of the optical path in the secondary scanning direction. Thus, the above problem in the case of the primary scanning direction does not occur, and it is not necessary to adjust the firing interval.

The control circuitry 351 may be provided as a part of the processor circuitry 53, or provided separately from the processor circuitry 53. The controls by the control circuitry 351 may be implemented by dedicated hardware, or by causing a general-purpose processor to execute necessary software, or by a combination thereof.

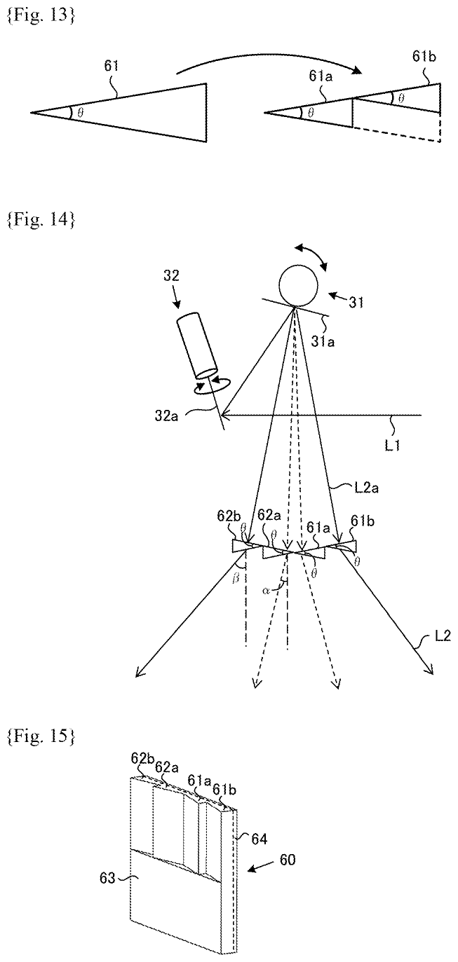

An example of detecting the rotation speed of the mirror 31a based on the voltage value of induced voltage generated in the sensing coil 317 is illustrated in FIG. 11, but the position of the mirror 31a may be first detected by an angle sensor, analyzing a captured image, or other methods, and then the rotation speed may be detected based on the speed of change in the detected position. The position of rotation of the mirror 32a may also be similarly measured.

[Modified Example of First Embodiment (FIG. 13 to FIG. 15)]

A modified example of the above-described first embodiment will be described with reference to FIG. 13 to FIG. 15.

FIG. 13 is a view illustrating a shape of the prism 61 in the modified example. FIG. 14 is a schematic view corresponding to FIG. 2, schematically showing an optical path of the scan beam L2a passing through prisms in the modified example. FIG. 15 is a perspective view showing a configuration of optical elements constituting the adjusting member 60 in the modified example.

The modified example of FIG. 13 to FIG. 15 is different from the first embodiment only in that the prisms 61, 62 are respectively composed of a plurality of components, but the other aspects are common. Only the difference will be described. The same or corresponding portions as those of the first embodiment are denoted by the same signs as those of the first embodiment.

In this modified example, as shown in FIG. 13 and FIG. 14, instead of the prism 61 in the first embodiment, small prisms 61a, 61b having the same apex angle θ as that of the prism 61 are arranged such that the surfaces thereof on the incident side of the scan beam L2a aligns on a common plane. Even if the prism 61 is divided into a plurality of prisms, the same refractive power as that of the prism 61 can be obtained as a whole as long as the apex angles are the same and the prisms are arranged in the same direction.

In this modified example, the thickness of the substrate opposite to the apex angle can become smaller in the prisms 61a, 61b if compared with the prism 61, so the adjusting member 60 can become thin wall and light weight. The light passing through the vicinity of the boundary between the prism 61a and the prism 61b may be scattered at the vertex, so the LD module 21 can be turned off also in the vicinity of the boundary. Since the propagating direction of the projected light L2 does not suddenly change in the vicinity of the boundary, the LD module 21 is not necessarily turned off but finely adjusting the lighting timing so that the boundary is located between the adjacent spots 101.

The prism 62 can be also divided into small prisms 62a and 62b in the same manner.

As shown in FIG. 15, optical elements of the adjusting member 60 is preferably configured as follows: all the prisms 61a, 61b, 62a, 62b are arranged such that the surfaces thereof on the incident side of the scan beam L2a aligns on a common plane, and a common transparent plate 64 is added to the incident side of the scan beam L2a. In such a structure, the prisms 61a, 61b, 62a, 62b and the transparent plates 63, 64 can be integrally molded from resin at low cost, and the number of components for assembling process can be reduced.

However, such integration is not essential, and the prisms 61a, 61b, 62a, 62b may be separated element. The prism with the refractive power corresponding to the prisms 61, 62 may be divided into three or more prisms.

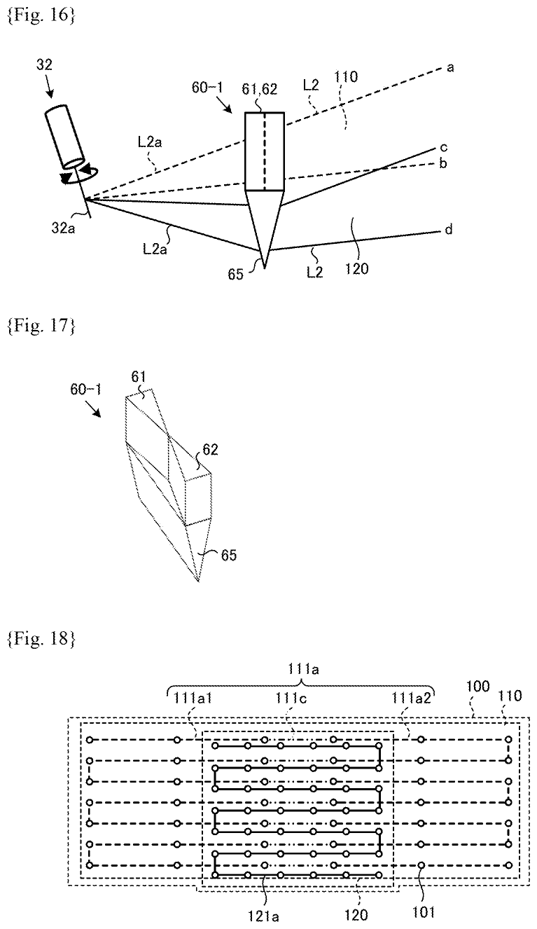

### Second Embodiment (FIG. 16 to FIG. 22)

An object detecting apparatus 10 according to a second embodiment of the present invention will be described.

The second embodiment is different from the first embodiment only in that an adjusting member 60-1 also has a power of adjusting the propagating direction of the scan beam L2a in the secondary scanning direction, and the other portions are the same. The difference will be described with reference to FIG. 16 to FIG. 18, and the description of other portions is omitted. The corresponding portions same as those of the first embodiment are denoted by the same signs as those of the first embodiment.

FIG. 16 is a schematic view showing an optical path of scan beam L2a and projected light L2 passing through an adjusting member 60-1 in a second embodiment in the secondary scanning direction. FIG. 17 is a perspective view showing a configuration of optical elements constituting the adjusting member 60-1 in the second embodiment. FIG. 18 is a view corresponding to FIG. 4, illustrating an example of scanning lines formed by the projected light L2 in the second embodiment.

In the adjusting member 60-1 of the second embodiment, the prisms 61, 62 are the same as those of the first embodiment, but a prism 65 shown in FIG. 17 is provided instead of the transparent plate 63. As shown in FIG. 16, the prism 65 is a third optical element that refracts the propagating direction of the incident scan beam L2a in the secondary scanning direction to the direction of the projected light L2 passing through the prisms 61, 62. The apex angle, refractive index and arrangement angle of the prism 65 are preferably determined as follows: the propagating range (the range between c and d in FIG. 16) of the projected light L2 passing through the prism 65 in the secondary scanning direction and the propagating range (the range between a and b in FIG. 16) of the projected light L2 passing through the prisms 61, 62 expand in parallel, that is, a and c, b and d are parallel, respectively. In addition, the surfaces of the prism 65 on the incident side and the outgoing side of the beam are preferably planar similar to those of the prisms 61, 62.

In the second embodiment, through the function of the prism 65 as described above, the first scanning range 110 and the second scanning range 120 can substantially overlap with each other in the secondary scanning direction as shown in FIG. 18 at positions located certain distance away from the object detecting apparatus 10. Therefore, the dead zone 111c in the first scanning range 110 can also be scanned by the primary scanning lines 121a of the second scanning range 120. The overlapping range of the primary scanning lines 111a and the primary scanning lines 121a can be simultaneously scanned, so high-density scanning can be performed.

Exactly, the first scanning range 110 and the second scanning range 120 do not completely overlap with each other because of difference between the positions of the prisms 61, 62 and the prism 65, and thus distance between a and c, and b and d is not zero. However, the size of each prism is, for example, a few centimeters, so when distance between a and c, and b and d are in tens of meters away, such difference can be ignored. Even if in the nearer range, the influence is also limited.

If the propagating range of the projected light L2 passing through the prism 65 is not completely parallel to but slightly deviated from the propagating range of the projected light L2 passing through the prisms 61, 62, the first scanning range 110 and the second scanning range 120 can also overlap partially to cover some sections of the dead zone 111c with the second scanning range 120. The more the first scanning range 110 and the second scanning range 120 overlap with each other, the narrower the FOV of the entire scanning range 100 in the secondary scanning direction becomes. Accordingly, width in the secondary scanning direction has a trade-off relation with the coverage of the dead zone 111c.

The same effect as that of the second embodiment is achieved by refracting the propagating direction of the scan beam L2a passing through the prisms 61, 62 to the direction of the projected light L2 passing through the transparent plate 63.

This refraction can be realized, for example, by providing a prism 66 with power opposite to that of the prism 65 to the adjusting member 60 of the first embodiment.

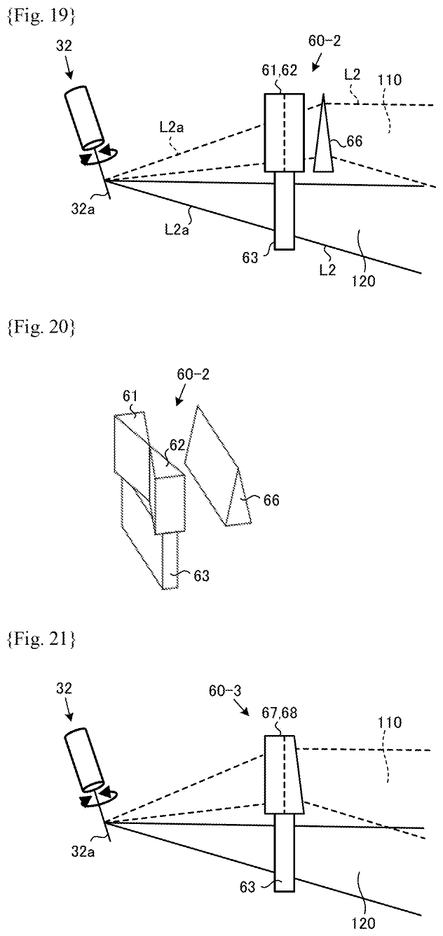

FIG. 19 is a schematic view corresponding to FIG. 16, showing an optical path of scan beam L2a and projected light L2 passing through an adjusting member 60-2 in which the optical refractive power of the prism 66 is appended to the prisms 61 and 62. FIG. 20 is a perspective view corresponding to FIG. 17, showing a configuration of optical elements in FIG. 19.

The same refraction function can also be realized by inclining the surface or surfaces whichever on the incident side and/or the outgoing side of the prisms 61, 62 along the secondary scanning direction, thereby appends the refractive power same as the prism 66 to the prisms 61, 62.

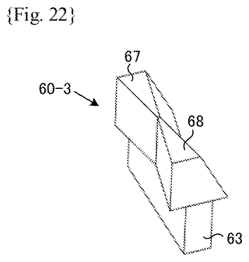

FIG. 21 is a schematic view corresponding to FIG. 16, showing an optical path of scan beam L2a and projected light L2 passing through an adjusting member 60-3. Compared with the prisms 61 and 62, the prisms 67 and 68 are used with the refractive power same as the prism 66 by inclining the surfaces located on the outgoing side of the beam. FIG. 22 is a perspective view corresponding to FIG. 17, showing a configuration of optical elements in FIG. 21.

Furtherly, in the case of using the prism 65, the prism 65 may be separated from the transparent plate 63 as described in FIG. 19 and FIG. 20.

Similar to the example explained with reference to FIG. 13 to FIG. 15, the third optical element such as the prisms 65 to 68 may be provided as a combination of a plurality of small prisms with the same refractive power. A common transparent plate may also be appended to these small prisms, which is similar to the example described with reference to FIG. 13 to FIG. 15.

[Embodiments with Other Modifications]

The embodiments in the present invention have been described. However, it should be noted that the present invention is not limited to the specific structure, specific operation sequence, specific shape of components of the apparatus, and the like described in the above embodiments.

The object detecting apparatus 10 described above can be configured in a compact size which is portable on a human palm, and it is suitable for but not limited to the application of an autonomous driving vehicle for the obstacle detection purpose. The object detecting apparatus 10 can also be mounted to a post, wall or the like as a stationary device for surveillance purpose.

The embodiment of a software program in the present invention is characterized in that it uses a computer or a plurality of computers to cooperatively control a specific hardware, thereby to realize the adjustment of the light-emitting timing of the LD module 21 in the object detecting apparatus 10, and/or to execute the related processes described in the embodiments.

The program might be stored in ROM or other non-volatile storage media (flash memory, EEPROM or the like) predetermined in a computer. The program might also be supplied and recorded in an external arbitrary non-volatile storage media such as a memory card, CD, DVD, Blu-ray Disc or the like. It is also possible to be downloaded from an external apparatus lo through a network and installed in a computer, and then is executed by such computer.

Certainly, the configurations of the invented embodiments and their modified substances can be implemented if without inconsistency in any combination of each other, or be implemented by omitting some parts of them.

### REFERENCE LIST

10 . . . object detecting apparatus, 20 . . . light projection unit, 21 . . . LD module, 22 . . . laser drive circuitry, 23 . . . collimating lens assembly, 30 . . . scanning assembly, 31, 32 . . . actuator, 31a, 32a . . . mirror, 40 . . . light reception unit, 41,45 . . . mirror, 42 . . . collective lens, 43 . . . light-receiving element, 44 . . . aperture, 51 . . . front-end circuitry, 52 . . . TDC circuitry, 53 . . . processor circuitry, 54 . . . input/output unit, 60, 60-1˜3 . . . adjusting member, 61, 61a, 61b, 62, 62a, 62b, 65-68 . . . prism, 63, 64 . . . transparent plate, 69 . . . surface passing through the boundary between the prisms 61 and 62, 71 . . . top cover, 72 . . . rear cover, 73 . . . cover clip, 74 . . . protective material, 75 . . . cavity member, 100, 100′. . . scanning range, 101 . . . spot, 101a, 101b . . . scanning line, 110 . . . first scanning range, 111a . . . primary scanning line, 111a1 . . . first portion of primary scanning lines, 111a2 . . . second portion of primary scanning lines, 111c . . . dead zone, 120 . . . second scanning range, 121a . . . primary scanning line, 316 . . . driving coil, 317 . . . sensing coil, 351 . . . control circuitry, 353 . . . drive signal, L1 . . . laser beam, L2 . . . projected light, L2a . . . scan beam, L3, L4 . . . returned light

1. A light scanning apparatus, comprising:
a scanning assembly comprising a light source and a rotatable reflecting surface and being configured to form a plurality of primary scanning lines at different positions in a secondary scanning direction by a light beam emitted from the light source and deflected by the reflecting surface, the plurality of primary scanning lines formed by the scanning assembly including a first primary scanning line having a first angular scanning range along a primary scanning direction; and
an optical member with refractive power and being configured to increase the first angular scanning range of the first primary scanning line formed by the scanning assembly, the optical member comprising a first optical element having an incident surface on which the light beam is incident and an emitting surface from which a refracted light beam is emitted such that as the light beam is scanned along the incident surface of the first optical element in the primary scanning direction within a first part of the first angular scanning range, the refracted light beam is emitted from the emitting surface of the first optical element at a second angular scanning range greater than the first part of the first angular scanning range,
wherein a refraction amount of the refracted light beam emitted from the emitting surface of the first optical element increases along the primary scanning direction such that a light beam incident on the incident surface of the first optical element at a position corresponding to a first end of the first part of the first angular scanning range is less strongly refracted by the first optical element than a light beam incident on the incident surface of the first optical element at a position corresponding to a second end of the first part opposite the first end of the first part, the second end of the first part corresponding to a first end of the first primary scanning line.

2. The light scanning apparatus according to claim 1, wherein
the optical member further comprises a second optical element having an incident surface on which a light beam is incident and an emitting surface from which a refracted light beam is emitted such that as the light beam is scanned along the incident surface of the second optical element in the primary scanning direction within a second part, different from the first part, of the first angular scanning range, the refracted light beam is emitted from the emitting surface of the second optical element at a third angular scanning range greater than the second part of the first angular scanning range,
wherein a refraction amount of the refracted light beam emitted from the emitting surface of the second optical element increases along the primary scanning direction such that a light beam incident on the incident surface of the second optical element at a position corresponding to a first end of the second part of the first angular scanning range is less strongly refracted by the second optical element than a light beam incident on the incident surface of the second optical element at a position corresponding to a second end of the second part opposite the first end of the second part, the second end of the second part corresponding to a second end of the first primary scanning line opposite the first end of the first primary scanning line.

3. The light scanning apparatus according to claim 2, wherein
the incident surface of the first optical element, the emitting surface of the first optical element, the incident surface of the second optical element, and the emitting surface of the second optical element are all planar surfaces.

4. The light scanning apparatus according to claim 2, wherein
the first optical element and the second optical element are adjacent in the primary scanning direction, and
the light scanning apparatus comprises a first boundary controller configured to turn off the light beam while the light beam passes through a boundary between the first optical element and the second optical element.

5. The light scanning apparatus according to claim 2, wherein
the first primary scanning line behind the optical member is formed with a gap between a first portion of the first primary scanning line formed by the light beam passing through the first optical element and a second portion of the first primary scanning line formed by the light beam passing through the second optical element,
the plurality of primary scanning lines further includes a second primary scanning line spaced apart from the first primary scanning line in the secondary scanning direction, and
the second primary scanning line scans at least an angular range that covers the gap in the primary scanning direction.

6. The light scanning apparatus according to claim 1, wherein
the plurality of primary scanning lines further includes a second primary scanning line spaced apart from the first primary scanning line in the secondary scanning direction, and
a first secondary angular scanning range of the first primary scanning line and a second secondary angular scanning range of the second primary scanning line at least partially overlap with each other in the secondary scanning direction outside the light scanning apparatus.

7. The light scanning apparatus according to claim 6, wherein
the optical member further comprises:
a third optical element configured to refract one or both of the light beam forming the first primary scanning line and the light beam forming the second primary scanning line so that the first secondary angular scanning range and the second secondary angular scanning range come closer to each other.

8. The light scanning apparatus according to claim 7, further comprising
a second boundary controller configured to turn off the light beam during a predetermined period around a boundary between a first period during which the light beam forms the first primary scanning line and a second period during which the light beam forms the second primary scanning line.

9. The light scanning apparatus according to claim 1,
wherein the scanning assembly is configured to form the plurality of primary scanning lines parallel to each other by the light beam, the light beam being an intermittently fired light beam,
the plurality of primary scanning lines further includes a second primary scanning line spaced apart from the first primary scanning line in the secondary scanning direction, and
wherein after transmitting through the optical member, spots formed by the light beam are sparser on the first primary scanning line than on the second primary scanning line.

10-14. (canceled)

15. An object detecting apparatus, comprising:
the light scanning apparatus according to claim 1;
a light-receiving element;
an optical assembly configured to guide incident light incident from outside to the light-receiving element along an optical axis same as that of the light beam projected by the light scanning apparatus; and
an object detecting assembly configured to detect a distance to an object located along an optical path of the projected light beam and a direction in which the object is located, based on a projection timing and a projection direction of the projected light beam and a timing of a light detection signal output by the light-receiving element,
wherein the light beam is a laser beam.

16. A light scanning method comprising:
scanning with a plurality of primary scanning lines that are formed by a light beam and at different positions in a secondary scanning direction, the plurality of primary scanning lines including a first primary scanning line having a first angular scanning range along a primary scanning direction; and
making the light beam forming the first primary scanning line among the plurality of primary scanning lines pass through an optical member with refractive power so as to increase the first angular scanning range of the first primary scanning line, the optical member comprising a first optical element having an incident surface on which the light beam is incident and an emitting surface from which a refracted light beam is emitted such that as the light beam is scanned along the incident surface of the first optical element in the primary scanning direction within a first part of the first angular scanning range, the refracted light beam is emitted from the emitting surface of the first optical element at a second angular scanning range greater than the first part of the first angular scanning range,
wherein a refraction amount of the refracted light beam emitted from the emitting surface of the first optical element increases along the primary scanning direction such that a light beam incident on the incident surface of the first optical element at a position corresponding to a first end of the first part of the first angular scanning range is less strongly refracted by the first optical element than a light beam incident on the incident surface of the first optical element at a position corresponding to a second end of the first part opposite the first end of the first part, the second end of the first part corresponding to a first end of the first primary scanning line.

17. The light scanning method according to claim 16, wherein
the plurality of primary scanning lines further includes a second primary scanning line spaced apart from the first primary scanning line in the secondary scanning direction, and
a first secondary angular scanning range of the first primary scanning line and a second secondary angular scanning range of the second primary scanning line at least partially overlap with each other in the secondary scanning direction within a specific distance range.

18. The light scanning method according to claim 16,
wherein the plurality of primary scanning lines are parallel to each other and formed by the light beam being an intermittently fired light beam,
the plurality of primary scanning lines further includes a second primary scanning line spaced apart from the first primary scanning line in the secondary scanning direction, and
wherein after being refracted by the optical member, spots formed by the light beam are sparser on the first primary scanning line than on the second primary scanning line.

19. An object detecting method, comprising:
scanning within a field of view through the light scanning method according to claim 16;
guiding incident light incident from the field of view to a light-receiving element along an optical axis same as that of the light beam projected for the scanning; and
detecting a distance to an object located along an optical path of the projected light beam and a direction in which the object is located, based on a projection timing and a projection direction of the projected light beam and a timing of a light detection signal output by the light-receiving element,
wherein the light beam is a laser beam.

20-24. (canceled)

25. The light scanning method according to claim 16,
wherein the optical member further comprises a second optical element having an incident surface on which a light beam is incident and an emitting surface from which a refracted light beam is emitted such that as the light beam is scanned along the incident surface of the second optical element in the primary scanning direction within a second part, different from the first part, of the first angular scanning range, the refracted light beam is emitted from the emitting surface of the second optical element at a third angular scanning range greater than the second part of the first angular scanning range,
wherein a refraction amount of the refracted light beam emitted from the emitting surface of the second optical element increases along the primary scanning direction such that a light beam incident on the incident surface of the second optical element at a position corresponding to a first end of the second part of the first angular scanning range is less strongly refracted by the second optical element than a light beam incident on the incident surface of the second optical element at a position corresponding to a second end of the second part opposite the first end of the second part, the second end of the second part corresponding to a second end of the first primary scanning line opposite the first end of the first primary scanning line.

26. The light scanning apparatus according to claim 1, wherein the scanning assembly includes two rotatable reflecting surfaces such that the plurality of primary scanning lines are formed by the light source and the two rotatable reflecting surfaces.

27. A light scanning apparatus, comprising:
a scanning assembly comprising a light source and a rotatable reflecting surface and being configured to form a plurality of primary scanning lines at different positions in a secondary scanning direction by a light beam emitted from the light source and deflected by the reflecting surface, the plurality of primary scanning lines formed by the scanning assembly including a first primary scanning line having a first angular scanning range along a primary scanning direction; and
an optical member comprising a first optical element having refractive power and a second optical element having refractive power,
wherein the first optical element and the second optical element having the refractive power are arranged such that, as a light beam corresponding to the first primary scanning line is scanned in the primary scanning direction, the light beam corresponding to the first primary scanning line is incident on both the first optical element and the second optical element to thereby increase the first angular scanning range of the first primary scanning line along the primary scanning direction.

28. The light scanning apparatus according to claim 27, wherein the optical member further comprises a third optical element without refractive power,
the plurality of primary scanning lines further includes a second primary scanning line spaced apart from the first primary scanning line in the secondary scanning direction, and
wherein the third optical element without the refractive power is arranged at a position in the secondary scanning direction different from positions of the first optical element and the second optical element such that, as a light beam corresponding to the second primary scanning line is scanned in the primary scanning direction, the light beam corresponding to the second primary scanning line is incident on the third optical element to thereby allow the light beam to pass through the third optical element without increasing an angular scanning range of the second primary scanning line.
